(19) United States
(12) Patent Application Publication
(10) Pub. No.: US 2026/0211188 A1
(43) Pub. Date: Jul. 23, 2026

(54) OPTICAL MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Hiroshi ANDO, Nisshin-shi (JP); Masaaki KAWAUCHI, Nisshin-shi (JP); Kojiro TACHI, Nisshin-shi (JP); Masatoshi TSUJI, Nisshin-shi (JP); Takashi INOUE, Nisshin-shi (JP)

(21) Appl. No.: 19/423,106

(22) Filed: Dec. 17, 2025

(30) Foreign Application Priority Data
Jan. 22, 2025 (JP) 2025-009426

(51) Int. Cl. G02B 6/34; B60R 1/10

(52) U.S. Cl. CPC G02B 6/34; B60R 1/10; B60R 2300/202

(57) ABSTRACT

An optical member for attachment to an inclined mounting member includes a light guide body made of a light-transmissive material with a specific refractive index. The light guide body has an incidence portion with incident prism portions for receiving external scene light, and an exit surface with exit prism portions for exiting part of the incident light. A reflective portion and a reflective surface direct light within the body, while terminal, upper, and lower surfaces connect the structural elements. The arrangement and inclination of the incidence edge, exit surface, and other surfaces are defined with respect to orthogonal axes. The structure enables guidance of light from a blind spot region, with geometric and optical relationships specified by equations.

### CROSS REFERENCE TO RELATED APPLICATION

This application is based on and claims the benefits of priority of Japanese Patent Application No. 2025-009426 filed on Jan. 22, 2025. The entire disclosure of which is incorporated herein by reference.

### TECHNICAL FIELD

The present disclosure relates to an optical member composed of a light-transmissive material.

### BACKGROUND

Conventional optical members have an incident surface that allows external light to enter an interior, an exit surface composed of triangular prism-shaped prism portions and flat portions facing the incident surface, and a reflective surface that reflects internally reflected light at the exit surface toward the exit surface side.

### SUMMARY

According to at least one embodiment, an optical member is attached to a mounting member that is inclined with respect to a vertical direction. The optical member guides external scene light from a region that includes a blind spot region caused by the mounting member. The optical member includes a light guide body made of a light-transmissive material having a refractive index n. The light guide body has an incidence portion with incident prism portions, and the incidence portion includes an incidence surface through which the external scene light enters the interior. The light guide body also has an exit surface with exit prism portions, and the exit surface includes an exit portion that exits part of the incident light from the incidence surface to the outside. Another part of the incident light is reflected by a reflective portion. A reflective surface reflects light that has been reflected by the reflective portion toward the exit surface. A terminal surface connects an end portion of the reflective surface opposite to the incidence surface and the exit surface. An upper surface connects the incidence portion and the exit surface, and a lower surface connects the incidence portion and the exit surface and is positioned opposite to the upper surface. An up-down direction along a vertical direction is defined as a Y-axis direction, a left-right direction orthogonal to the Y-axis direction and connecting the light guide body and the mounting member is defined as an X-axis direction, and a front-rear direction orthogonal to both the X-axis direction and the Y-axis direction is defined as a Z-axis direction. A plane formed by the X-axis direction and the Y-axis direction is an XY plane, a plane formed by the Y-axis direction and the Z-axis direction is a YZ plane, and a plane formed by the X-axis direction and the Z-axis direction is an XZ plane. An edge of the incidence portion at an end opposite to the reflective surface is an incidence edge, and an edge of the exit surface at an end on the terminal surface side is a terminal edge. The light guide body is arranged so that, with respect to the Y-axis direction, the incidence edge is inclined at an angle θx in the YZ plane and at an angle θz in the XY plane. A straight line connecting a point on the terminal edge and a user's viewpoint position is a virtual line, and an angle between the virtual line and the Z-axis direction in the YZ plane is φx, while an angle between the virtual line and the Z-axis direction in the XZ plane is φy. A direction in which the exit prism portions are arranged and which is orthogonal to an extending direction of the exit prism portions is a small-z-direction. An apparent incident angle between the external scene light incident on the incidence portion and the small-z-direction is α, and an angle between the incidence surface and a normal direction to the reflective surface is φx. The relationship sin φx/sin φy=tan δ is satisfied. An angle between the upper surface or the lower surface and the small-z-direction, which is an ideal angle calculated by equation (5) and equation (6), is ωo, and an angle ω satisfying 0≤ω≤10 is an inclination reference angle. An actual angle between the upper surface and the small-z-direction is ωu, and an actual angle between the lower surface and the small-z-direction is ωd. The upper surface satisfies ωu≤ω, and the lower surface satisfies ωd≥ω. Among the light exited from the exit surface, the light having the largest number of round trips between the reflective portion and the reflective surface is maximum round-trip light, and a distance traveled by the maximum round-trip light from the incidence portion to the exit portion in a direction orthogonal to the incidence edge in a plane of the reflective surface is Wd, and Wd satisfies equation (4).

$$\begin{matrix}< Math 5 > & \\ α = {sin}^{- 1} ( \sqrt{( {sin}^{2} ( ϕx ) + {sin}^{2} ( ϕy ) ) / ( 1 + 1 / {tan}^{2} ( δ + {θ}_{z} ) )} ) & ( 5 )\end{matrix}$$

$$\begin{matrix}< Math 6 > & \\ ω o = {sin}^{- 1} ( sin ( θ x + α ) / {n}^{cos ψ x} ) & ( 6 )\end{matrix}$$

$$\begin{matrix}< Math 4 > & \\ Wd \leq \frac{\frac{52 \times cos ω}{cos θ z}}{sin ( ϕ x + θ x - ω )} & ( 4 )\end{matrix}$$

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating an optical member and an example of a mounting of the optical member according to a first embodiment.

FIG. 2 is a perspective view of a light guide according to the first embodiment.

FIG. 3 is a cross-sectional view taken along a line III-III of FIG. 2.

FIG. 4 is an explanatory diagram illustrating an apparent incident angle of external light entering the light guide, an angle of incident light, an inclination angle of an upper surface, and the inclination angle of a lower surface.

FIG. 5 is an explanatory diagram illustrating light guiding within the light guide and a cross-sectional light guiding distance.

FIG. 6 is an explanatory diagram illustrating an amount of displacement between exited light from the light guide and real-world light.

FIG. 7 is an explanatory diagram illustrating the inclination angle of an incident portion in an XY plane.

FIG. 8 is an explanatory diagram illustrating the inclination angle of the incident portion in a YZ plane, as well as an angle of the exited light reaching a viewpoint position.

FIG. 9 is an explanatory diagram illustrating an invisible region that occurs in the light guide of a first comparative example having a rectangular plate shape.

FIG. 10 is a diagram showing a state of FIG. 9 as viewed from a user's viewpoint position.

FIG. 11 is an explanatory diagram illustrating the invisible region when the light guide of the first comparative example in FIG. 9 is arranged in an inclined configuration.

FIG. 12 is a diagram showing a state of FIG. 11 as viewed from the user's viewpoint position.

FIG. 13 is an explanatory diagram illustrating an invisible region that occurs in the light guide of a second comparative example having a parallelogram plate shape.

FIG. 14 is an explanatory diagram regarding an angle, in an XZ plane, of exited light that reaches the viewpoint position.

FIG. 15 is an explanatory diagram illustrating an apparent incident angle of external light entering a light guide according to a second embodiment, an angle of incident light, an inclination angle of an upper surface, and the inclination angle of a lower surface.

FIG. 16 is an explanatory diagram illustrating an inclination angle of an incident portion in a YZ plane, as well as an angle of exited light reaching a viewpoint position.

FIG. 17 is an explanatory diagram regarding an angle, in an XZ plane, of the exited light that reaches a viewpoint position.

FIG. 18 is a diagram corresponding to FIG. 5, and is an explanatory diagram of a light guide and a cross-sectional light guiding distance according to a third embodiment.

FIG. 19 is a diagram corresponding to FIG. 5, and is an explanatory diagram of a light guide and a cross-sectional light guiding distance according to a fourth embodiment.

### DETAILED DESCRIPTION

To begin with, examples of relevant techniques will be described.

An optical member of a comparative example is provided with an incident surface that allows external light to enter an interior, an exit surface composed of triangular prism-shaped prism portions and flat portions facing the incident surface, and a reflective surface that reflects internally reflected light at the exit surface toward the exit surface side, and includes a light guide made of a translucent material. The optical member exits a portion of the light incident from the incident surface toward a user side from one face of the prism portion. Additionally, another portion of the incident light is reflected by the flat portion and the reflective surface. As a result, the optical member is used as a blind spot assist device that allows the user to visually recognize a scene in a blind spot area.

The optical member of the comparative example may be attached to a member that is inclined with respect to a vertical direction, such as an A-pillar of an automobile. In this case, the light entering the incident surface is refracted when entering the interior. As a result, there are regions on an exit surface where the incident light does not reach. The regions where the incident light does not reach are recognized by the user as invisible areas where the scene cannot be visually recognized. Furthermore, due to the refraction, the incident light travels downward inside the light guide. Therefore, the light reaching the user's eyes includes exited light exited from the exit surface and real scene light that reaches directly without passing through the optical member. A parallax occurs between these types of light. When the parallax exceeds a predetermined value, the user's visibility decreases.

In contrast to the comparative example, the optical member according to the present disclosure is made of a translucent material. When the optical member is attached to a member inclined relative to a vertical direction, an invisible area can be reduced. Additionally, a decrease in visibility due to parallax between the exited light and the actual scene light can also be reduced.

According to one aspect of the present disclosure, an optical member is attached to a mounting member that is inclined with respect to a vertical direction. The optical member guides external scene light from a region that includes a blind spot region caused by the mounting member. The optical member includes a light guide body made of a light-transmissive material having a refractive index n. The light guide body has an incidence portion with incident prism portions, and the incidence portion includes an incidence surface through which the external scene light enters the interior. The light guide body also has an exit surface with exit prism portions, and the exit surface includes an exit portion that exits part of the incident light from the incidence surface to the outside. Another part of the incident light is reflected by a reflective portion. A reflective surface reflects light that has been reflected by the reflective portion toward the exit surface. A terminal surface connects an end portion of the reflective surface opposite to the incidence surface and the exit surface. An upper surface connects the incidence portion and the exit surface, and a lower surface connects the incidence portion and the exit surface and is positioned opposite to the upper surface. An up-down direction along a vertical direction is defined as a Y-axis direction, a left-right direction orthogonal to the Y-axis direction and connecting the light guide body and the mounting member is defined as an X-axis direction, and a front-rear direction orthogonal to both the X-axis direction and the Y-axis direction is defined as a Z-axis direction. A plane formed by the X-axis direction and the Y-axis direction is an XY plane, a plane formed by the Y-axis direction and the Z-axis direction is a YZ plane, and a plane formed by the X-axis direction and the Z-axis direction is an XZ plane. An edge of the incidence portion at an end opposite to the reflective surface is an incidence edge, and an edge of the exit surface at an end on the terminal surface side is a terminal edge. The light guide body is arranged so that, with respect to the Y-axis direction, the incidence edge is inclined at an angle θx in the YZ plane and at an angle θz in the XY plane. A straight line connecting a point on the terminal edge and a user's viewpoint position is a virtual line, and an angle between the virtual line and the Z-axis direction in the YZ plane is φx, while an angle between the virtual line and the Z-axis direction in the XZ plane is φy. A direction in which the exit prism portions are arranged and which is orthogonal to an extending direction of the exit prism portions is a small-z-direction. An apparent incident angle between the external scene light incident on the incidence portion and the small-z-direction is α, and an angle between the incidence surface and a normal direction to the reflective surface is φx. The relationship sin φx/sin φy=tan δ is satisfied. An angle between the upper surface or the lower surface and the small-z-direction, which is an ideal angle calculated by equation (5) and equation (6), is ω, and an angle ω satisfying 0≤ω≤10 is an inclination reference angle. An actual angle between the upper surface and the small-z-direction is ωu, and an actual angle between the lower surface and the small-z-direction is ωd. The upper surface satisfies ωu≤ω, and the lower surface satisfies ωd≥ω. Among the light exited from the exit surface, the light having the largest number of round trips between the reflective portion and the reflective surface is maximum round-trip light, and a distance traveled by the maximum round-trip light from the incidence portion to the exit portion in a direction orthogonal to the incidence edge in a plane of the reflective surface is Wd, and Wd satisfies equation (4).

$$\begin{matrix}< Math 5 > & \\ α = {sin}^{- 1} ( \sqrt{( {sin}^{2} ( ϕx ) + {sin}^{2} ( ϕy ) ) / ( 1 + 1 / {tan}^{2} ( δ + {θ}_{z} ) )} ) & ( 5 )\end{matrix}$$

$$\begin{matrix}< Math 6 > & \\ ω o = {sin}^{- 1} ( sin ( θ x + α ) / {n}^{cos ψ x} ) & ( 6 )\end{matrix}$$

$$\begin{matrix}< Math 4 > & \\ Wd \leq \frac{\frac{52 \times cos ω}{cos θ z}}{sin ( ϕ x + θ x - ω )} & ( 4 )\end{matrix}$$

In this optical member, with respect to the angle ωo calculated by equations (5) and (6), by setting the inclination reference angle ω that satisfies ωo−10°≤ω≤ωo+10°, and having the upper surface satisfy ωu≤ω and the lower surface satisfy ωd≥ω, the occurrence of invisible regions is suppressed. Furthermore, in this optical member, when Wd, which is a distance traveled by a maximum round-trip light in a direction orthogonal to an incidence edge from an incidence portion to an exit portion, satisfies equation (4), parallax remains at or below a predetermined level, thereby suppressing the reduction in visibility caused by parallax.

Hereinafter, embodiments of the present disclosure will be described with reference to the drawings. In the following embodiments, the same or equivalent parts are denoted by the same reference numerals.

### First Embodiment

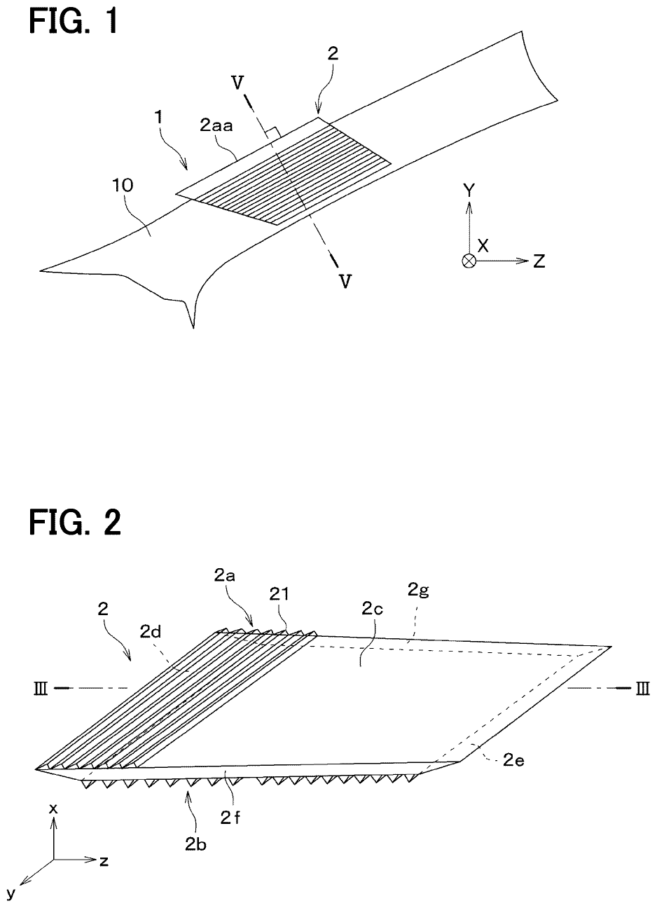

Next, an optical member 1 according to a first embodiment will be described. The optical member 1 of the present embodiment can be used, for example, as a blind spot assistance device that is attached to a member, an obstacle, or the like that blocks a field of view of a user and causes a blind spot, and makes the view within the blind spot visible to the user. As shown in FIG. 1, the optical member 1 is attached to a mounting member 10 of a light-shielding body, which has a portion inclined with respect to a vertical direction. The optical member 1 guides external light from an area that becomes a blind spot due to the light-shielding body to a user side. As a result, the user can visually recognize a scene in the blind spot area. In a case of in-vehicle applications, the mounting member 10 may be an A-pillar of a vehicle in which it is installed, but is not limited thereto.

In this specification, a case in which the optical member 1 is a blind spot assistance device for in-vehicle use and the mounting member 10 is the A-pillar of a vehicle will be described as a representative example. For convenience of explanation, as shown in FIG. 1, a direction along the vertical direction is referred to as a Y-axis direction. A direction perpendicular to the Y-axis direction and connecting a light guide 2 and the mounting member 10 is referred to as an X-axis direction. A direction perpendicular to both the X-axis direction and the Y-axis direction is referred to as a Z-axis direction. The X-axis direction corresponds to a width direction of a vehicle body, that is, a left-right direction. The Y-axis direction corresponds to an up-down direction of the vehicle body. The Z-axis direction corresponds to an overall length direction of the vehicle body, that is, a front-rear direction. A plane including the X-axis direction and the Y-axis direction is referred to as an XY plane. A plane including the X-axis direction and the Z-axis direction is referred to as an XZ plane. A plane including the Y-axis direction and the Z-axis direction is referred to as a YZ plane.

The optical member 1 of the present embodiment includes, for example, a light guide 2 as shown in FIG. 2, and a holding member (not shown) that holds the light guide 2 on the mounting member 10. The optical member is used in a state where an exit surface 2b (described later) of the light guide 2 is oriented toward a user's viewpoint side. The holding member (not shown) may, for example, be formed as a separate component from the light guide 2 and the mounting member 10, but it may also be formed directly on the mounting member 10. The optical member 1 guides light from the blind spot area within the light guide 2 and exits it toward the user side, thereby allowing the user to visually recognize the scene in the blind spot area. The optical member 1 is mounted in a state inclined with respect to the vertical direction in accordance with an inclination of the mounting member 10. In addition, angles of an upper surface 2f and a lower surface 2g (described later) of the light guide 2 are adjusted, thereby providing a configuration capable of reducing invisible areas and parallax. In FIG. 2, in order to clarify surfaces of the light guide 2 that are not directly visible from an illustrated angle, portions of an outline of the light guide 2 that are not visible are indicated by broken lines.

The light guide 2 is, for example as shown in FIG. 2, a member having an incident portion 2a, a reflective surface 2c adjacent to the incident portion 2a, an exit surface 2b facing the incident portion 2a and the reflective surface 2c, a lateral surface 2d connecting the incident portion 2a and the exit surface 2b, and a terminal surface 2e connecting the exit surface 2b and the reflective surface 2c. The light guide 2, as shown for example in FIG. 2, has an upper surface 2f and a lower surface 2g, which are opposing surfaces that connect the incident portion 2a, the exit surface 2b, the reflective surface 2c, the lateral surface 2d, and the terminal surface 2e. The light guide 2 is, for example, a single transparent member made of a light-transmitting material. As the light-transmitting material, for example, resin materials such as polyethylene terephthalate, polycarbonate, polyethylene, or acrylic, or inorganic materials such as glass, can be used. In the present embodiment, the light guide 2 has a mirrorless structure that does not include a mirror made of a reflective material different from the light-transmitting material, and is designed to guide light by totally internally reflecting the incident light entering from the incident portion 2a.

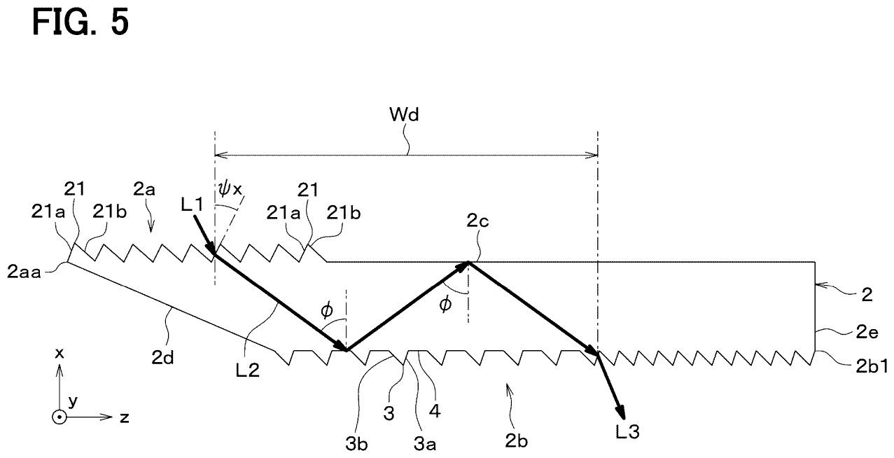

Hereinafter, for convenience of explanation, as shown in FIG. 5, the light traveling toward the light guide 2 from the incident portion 2a side is referred to as external scene light L1, and of the external scene light L1, the light that enters an interior from the incident portion 2a is referred to as incident light L2. In addition, among the incident light L2, the light that is exited to an outside from an exit prism portion 3, which will be described later, is referred to as exited light L3.

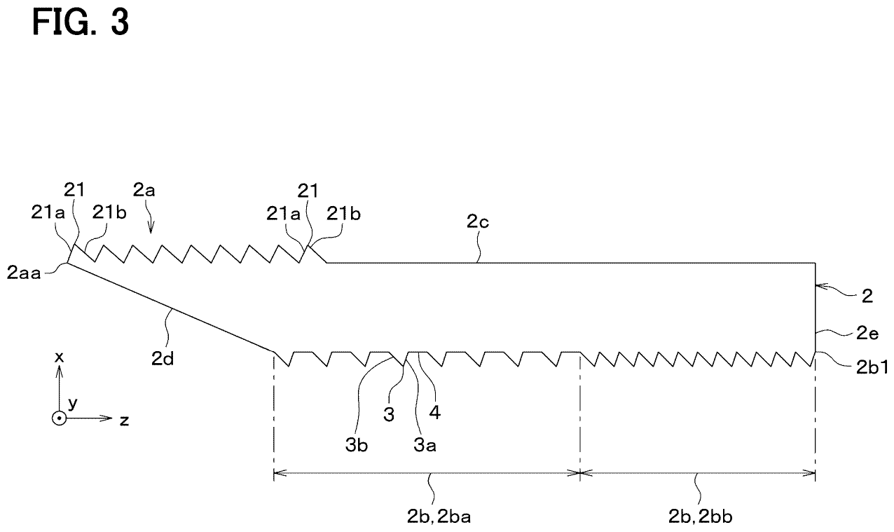

The incident portion 2a is formed, for example, by arranging incident prism portions 21, each being a triangular protrusion in cross-sectional view, in a repeated and continuous manner with their extending directions aligned. As shown in FIG. 3, for example, among the incident prism portions 21, a surface on a side opposite to the reflective surface 2c adjacent to the incident portion 2a serves as the incident surface 21a, which allows a portion of the external scene light L1 to enter the interior. The incident prism portions 21 are, for example, arranged such that a height of the portions protruding from the reflective surface 2c is substantially uniform, and each incident surface 21a is arranged to be substantially parallel to one another. The term “substantially uniform” includes not only cases where dimensions are exactly the same, but also cases where, due to unavoidable errors such as manufacturing tolerances, they are not completely identical but are nearly the same. In the incident prism portions 21, the surface on the reflective surface 2c side of the outer surface serves as an adjacent surface 21b. The adjacent surface 21b is set at an inclination angle that is at or below a predetermined value so as not to obstruct the entry of external scene light L1 into the incident surface 21a of an adjacent incident prism portion 21. Taking one side of an end portion of the incident portion 2a opposite to the reflective surface 2c as an incident end 2aa, the incident end 2aa is, for example, substantially parallel to the extending direction of the incident prism portion 21. The term “substantially parallel” includes not only cases where elements are exactly parallel, but also cases where, despite unavoidable errors such as manufacturing tolerances, they can be regarded as nearly parallel.

The exit surface 2b includes, for example, exit prism portions 3, which are triangular protrusions in cross-sectional view, and flat portions 4, which are adjacent to these prism portions and are planar surfaces substantially parallel to the reflective surface 2c. The exit surface 2b is a surface on which the incident light L2 from the incident portion 2a first arrives. As shown, for example, in FIG. 3, the exit surface 2b is composed of a first region 2ba, in which the exit prism portions 3 and the flat portions 4 are alternately and repeatedly arranged, and a second region 2bb, in which only the exit prism portions 3 are repeatedly arranged. The first region 2ba is positioned on a side of the incident portion 2a, facing the incident portion 2a. The first region 2ba is a region where both the exit of the incident light L2 to the outside and internal reflection take place. The second region 2bb is positioned on a side of the terminal surface 2e, facing the reflective surface 2c. The second region 2bb is a region where internal reflection of the incident light L2 does not occur, and a portion of the incident light L2 is exited to the outside as exited light L3.

The exit prism portions 3 each have an exit portion 3a, which is a surface that exits the incident light L2 to the outside, and another adjacent surface 3b, and, for example, are arranged in parallel with their extension directions aligned. The exit portion 3a is, for example, approximately parallel to the incident surface 21a. The exit prism portion 3 is aligned in its extension direction with the incident prism portion 21.

The flat portions 4 are, for example, flat surfaces located on the same plane, and serve as first reflective surfaces that reflect the incident light L2 toward the reflective surface 2c by means of total internal reflection. In other words, the flat portion 4 can also be referred to as a reflective portion, and, for example, is approximately parallel to the reflective surface 2c. Here, an angle formed between a normal direction (hereinafter simply referred to as “normal direction”) to a plane defined by the flat portion 4 or the reflective surface 2c and a travel direction of the incident light L2 is referred to as an incident angle φ, and a refractive index of the constituent material is denoted as “n” (where n>1). At this time, the light guide 2 is able to guide light in a mirrorless structure by satisfying a condition for total internal reflection given by the following equation (1), assuming that an external medium is air (refractive index=1).

$$sin φ \geq 1 / n \qquad ( 1 )$$

Hereinafter, for convenience of explanation, a direction along the normal direction is referred to as an “x-direction,” a direction along which the incident prism portion 21 or the exit prism portion 3 extends is referred to as a “y-direction,” and a direction orthogonal to the y-direction along a plane formed by the flat portion 4 is referred to as a “z-direction” or a “small-z-direction.” When the three axes, the X-axis direction, Y-axis direction, and Z-axis direction, which are independent of the orientation of the light guide 2, are defined as global directions, the three directions x, y, and z can be referred to as local directions that change depending on the orientation of the light guide 2. The x-direction corresponds to a thickness direction of the light guide 2, and the z-direction is one of directions in which the incident light L2 is guided.

The reflective surface 2c is a second reflective surface that reflects, by total internal reflection, the reflected light, among the incident light L2, that has been reflected at the flat portion 4, toward the exit surface 2b side. The reflective surface 2c corresponds to a rear surface when the exit surface 2b, which faces the user side, is regarded as a front surface. The reflective surface 2c faces the mounting member 10 with a predetermined gap therebetween.

The lateral surface 2d, for example, is inclined at an angle equal to or greater than the above-mentioned incident angle q, so that the incident light L2 is not exited to the outside through the lateral surface 2d. The lateral surface 2d, for example, may be a flat surface, however, as long as it does not hinder the incident light L2 from traveling toward the exit surface 2b, the surface shape may be modified as appropriate.

The terminal surface 2e is a surface where a portion of the incident light L2 ultimately arrives. The terminal surface 2e, for example, is a flat surface connecting the exit portion 3a of the exit prism portion 3, which is located farthest from the lateral surface 2d, to the reflective surface 2c, however, other surface shapes may also be used, and it may form a single plane together with the exit portion 3a, or it may have any arbitrary shape.

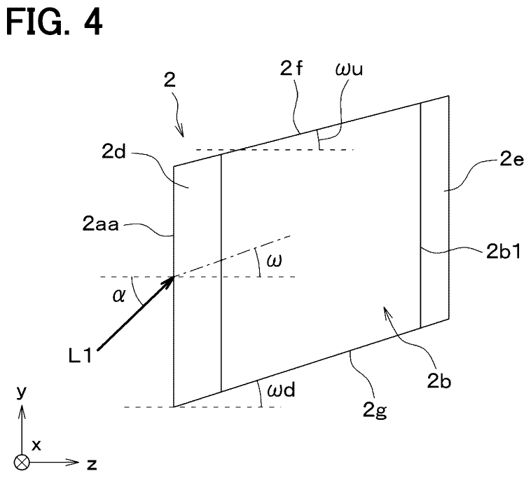

The upper surface 2f and the lower surface 2g, like the lateral surface 2d, are non-optical surfaces that are not used for guiding, that is, reflecting, the incident light L2 inside the light guide 2. The upper surface 2f and the lower surface 2g are, for example, each formed as a single flat surface connecting the entrance portion 2a, the exit surface 2b, the reflective surface 2c, the lateral surface 2d, and the terminal surface 2e. The upper surface 2f and the lower surface 2g are either parallel to each other or are inclined relative to each other so that a distance between them in the y-direction becomes narrower from the lateral surface 2d toward the terminal surface 2e. As shown in FIG. 4, for example, when viewed from the exit surface 2b side, an actual angle formed between an edge of the upper surface 2f and the z-direction is defined as a first inclination angle ωu, and with a reference inclination angle, described later, defined as ω, a configuration is such that ωu≤ω is satisfied. In FIG. 4, for ease of understanding, some components of the light guide 2, such as the exit prism portion 3, are omitted, and only a portion of an outline is shown. When viewed from the exit surface 2b side, an actual angle formed between an edge of the lower surface 2g and the z-direction is defined as a second inclination angle ωd, and a configuration is such that ωd≥ω is satisfied. As a result, the optical member 1 reduces a non-visible region on the exit surface 2b. Details regarding the non-visible region, as well as ω, ωu, and ωd, will be described later.

As shown in FIG. 5, for example, the light guide 2 has a cross-sectional light guide distance defined as Wd, and satisfies the following equation (2). The light guide distance Wd refers to a distance traveled in a light guiding direction, that is, along a direction of a surface formed by the reflective surface 2c or the flat portion 4, in a cross-section perpendicular to the incident end 2aa, until the maximum reciprocating light reaches the exit portion 3a from the incident portion 2a. The maximum reciprocating light refers to the incident light L2 that, among the light exited externally, undergoes the greatest number of round trips between the flat portion 4 and the reflective surface 2c. For example, in a case where the exit surface 2b is composed of two regions, 2ba and 2bb, the maximum reciprocating light refers to the portion of the incident light L2 from the incident portion 2a that first reaches the flat portion 4 as a half round trip, resulting in light that undergoes one and a half round trips within the light guide 2.

$$\begin{matrix}< Math 2 > & \\ Wd = \frac{\frac{L p \times cos ω}{cos θ z}}{sin ( ϕ x + θ x - ω )} & ( 2 )\end{matrix}$$

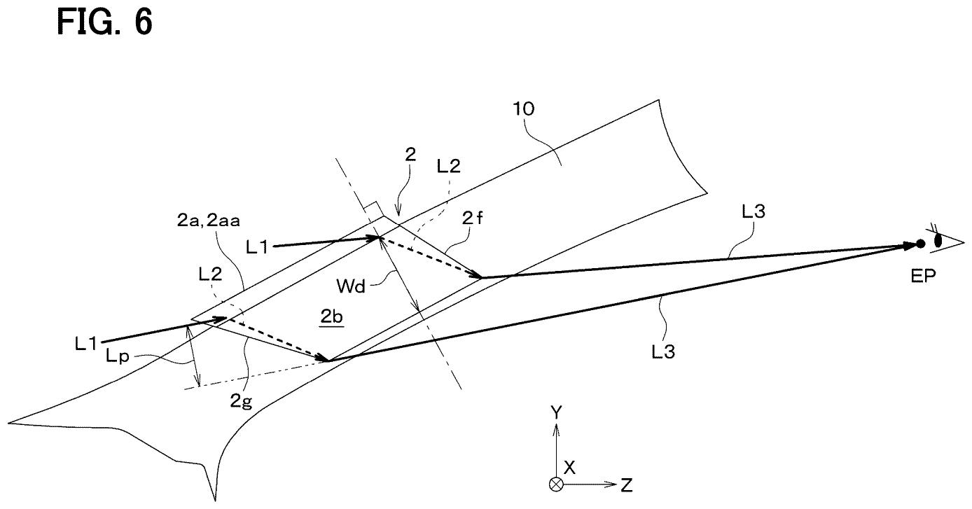

In equation (2), “Lp” refers to an amount of displacement (in mm) in the vertical direction between the exited light L3 that reaches the user's eye, for example, the viewpoint position EP, and a portion of the external scene light L1 that becomes this exited light L3, as shown, for example, in FIG. 6. In FIG. 6, the incident light L2 is indicated by a broken line, and an extension line of the exited light L3 is indicated by a two-dot chain line. For clarity, structural components such as the incident prism portion 21 and the exit prism portion 3 of the light guide 2 are omitted, and only a portion of the outer contour is shown. The vertical direction refers to a direction orthogonal to the exited light L3. The displacement amount Lp occurs when the light guide 2 is inclined along a slope of the mounting member 10, causing the extension direction of the incident prism portion 21 to be tilted relative to the Y-axis direction, and when the external scene light L1 is refracted upon entering the light guide 2 and becomes the incident light L2. The displacement amount Lp is a distance, in the aforementioned vertical direction, between the exited light L3 and the external scene light L1 on the YZ plane, and among the exited light L3, the one corresponding to the maximum round-trip light is the largest.

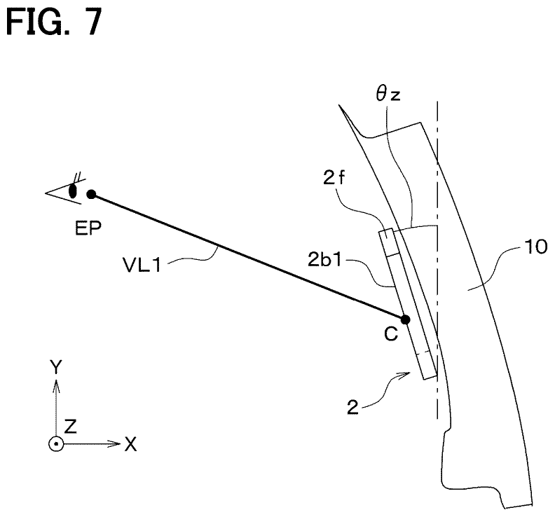

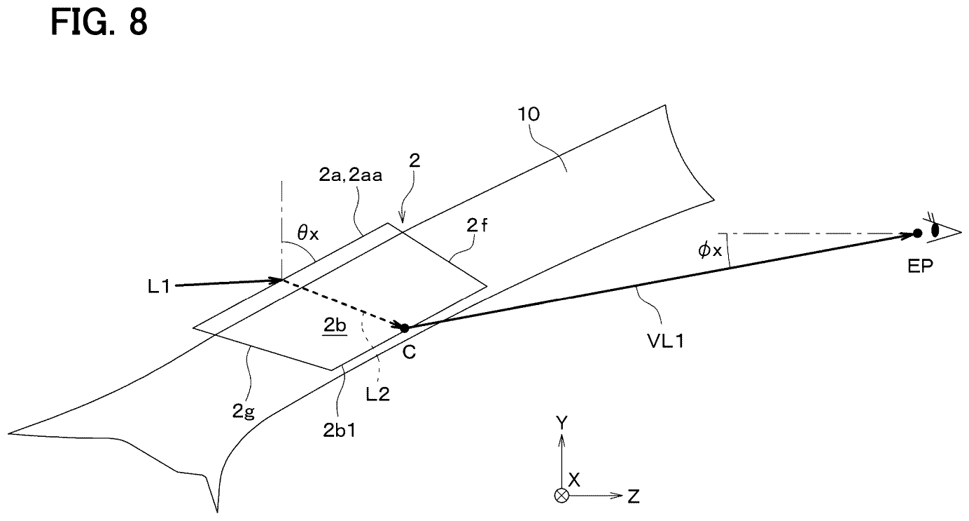

Further, “Oz” in Equation (2) refers to, for example as shown in FIG. 7, an angle (in degrees) formed between the Y-axis direction and the incident end 2aa of the light guide 2 on the XY plane, that is, an inclination angle of the incident end 2aa on the XY plane. “θx” in Equation (2) refers to, for example as shown in FIG. 8, an angle (in degrees) formed between the incident end 2aa of the light guide 2 and the Y-axis direction on the YZ plane, that is, an inclination angle of the incident end 2aa on the YZ plane. “φx” in Equation (2) refers to an angle (in degrees) on the YZ plane formed between a virtual straight line VL1, which connects the user's viewpoint position EP located behind the light guide 2 in the Z-axis direction and a point C on the terminal edge 2b1, and the Z-axis direction. In other words, φx corresponds to an angle of incidence on the YZ plane of the exited light L3, which is exited from point C among the incident light L2 that entered from the incident portion 2a, as it reaches the viewpoint position EP. The virtual straight line VL1 can also be described as a direction along the exited light L3, which is exited from point C and reaches the viewpoint position EP. The term “behind in the Z-axis direction” refers to a direction located further to a rear than the light guide 2, with a rear direction defined as a direction from the incident end 2aa toward the terminal edge 2b1 along the Z-axis. Here, the “rear direction” refers to a direction indicated by an arrow showing the Z-axis direction in FIG. 8 and the like, that is, a positive direction of the Z-axis. The terminal edge 2b1 is an edge located at a boundary between the exit surface 2b and the terminal surface 2e. Point C is, for example, a center of the terminal edge 2b1. The viewpoint position EP, when the optical member 1 is mounted in the vehicle, is any point (usually the center point) within a region known as an eye range or an eye ellipse, which is an elliptical area statistically representing the distribution of the driver's eye positions. The eye ellipse is defined, for example, in Japanese Industrial Standard JIS D0021:1998.

Here, when a driver operating a vehicle is looking at a point 40 meters ahead, a driver's depth of field ranges from approximately 3 meters to infinity. An apparent angular difference (in degrees) between the exited light L3 from the light guide 2 that reaches the driver's viewpoint position and the actual scene light is defined as the parallax ψ. A distance (unit: m) to the actual scene recognized by the driver is defined as a viewing distance D. At this time, the parallax ψ is expressed by the following equation (3).

$$Ψ = {tan}^{- 1} ( Lp / D ) \qquad ( 3 )$$

When the parallax ψ exceeds 1°, an image formed by the exited light L3 and the real scene light on the human eye become misaligned, resulting in a sense of discomfort in recognizing the scene. Furthermore, the discomfort caused by the parallax ψ increases as the viewing distance D decreases. In the above example of a driver, the discomfort caused by the parallax ψ is greatest when the viewing distance D is 3 meters. Therefore, in order to reduce the discomfort due to parallax ψ, it is sufficient to keep the parallax ψ at 3 meters viewing distance to 1° or less. According to equation (3), a condition ψ=tan⁻¹ (Lp/3000)≤1° is satisfied when Lp≤52, so it is sufficient to set the displacement amount Lp to 52 mm or less. Accordingly, in a case of in-vehicle applications, the optical member 1 is preferably designed to satisfy Lp≤52 in Equation (2) from the viewpoint of parallax suppression, that is, to satisfy the following Equation (4).

$$\begin{matrix}< Math 4 > & \\ Wd \leq \frac{\frac{52 \times cos ω}{cos θ z}}{sin ( ϕ x + θ x - ω )} & ( 4 )\end{matrix}$$

The basic configuration of the optical member 1 has been described above. It should be noted that, from the perspective of reducing ghost images, a light-shielding film (not shown) made of a light-shielding material such as black paint or light-shielding tape may be formed on non-optical surfaces of the light guide 2, such as the lateral surface 2d, the upper surface 2f, and the lower surface 2g, of the optical member 1.

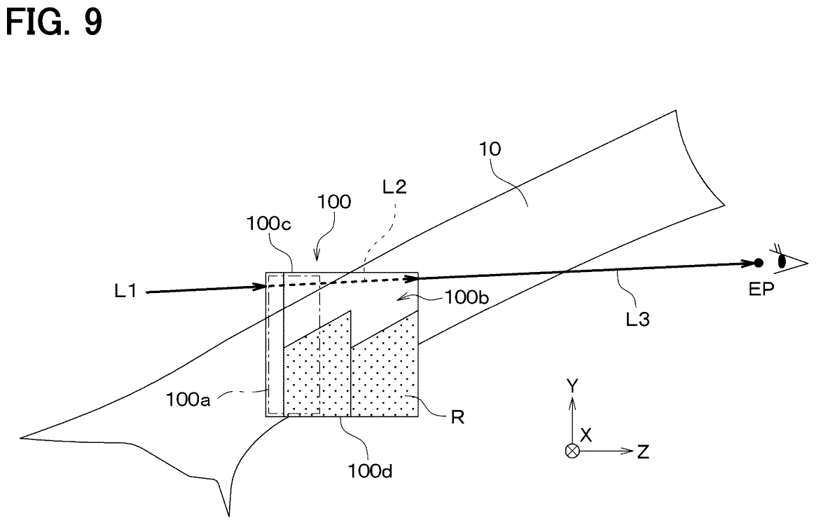

Next, the invisible region that occurs in the light guide composed of the translucent material having a refractive index n (n>1) will be explained. First, an occurrence of the invisible region in a light guide 100 of a first comparative example shown in FIG. 9 will be described. In FIG. 9, in order to clarify a structure of the light guide 100, an approximate area of the incident portion 100a described later located on an opposite side at a back of the page is indicated by a dash-dot-dash line.

The light guide 100 includes an incident portion 100a composed of incident prism portions (not shown), an exit surface 100b composed of exit prism portions and flat portions (not shown), and a reflective surface, lateral surfaces, and an end surface (all not shown). These configurations are the same as those of the light guide 2. The light guide 100, as shown for example in FIG. 9, is similar to the light guide 2 in that it has an upper surface 100c and a lower surface 100d. The light guide 100 differs from the light guide 2 in that its upper surface 100c and lower surface 100d are flat surfaces that are orthogonal and parallel, respectively, to an extending direction of the incident prism portions (not shown), that is, a prism extending direction.

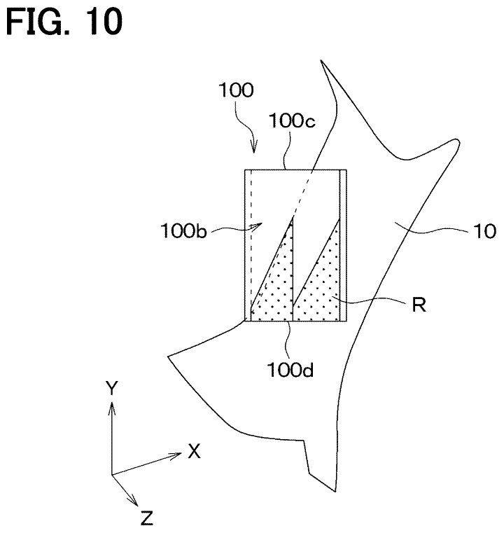

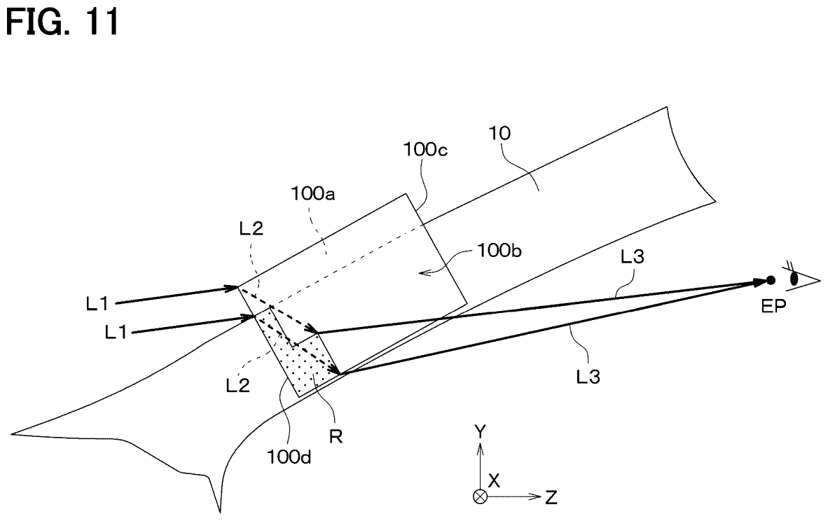

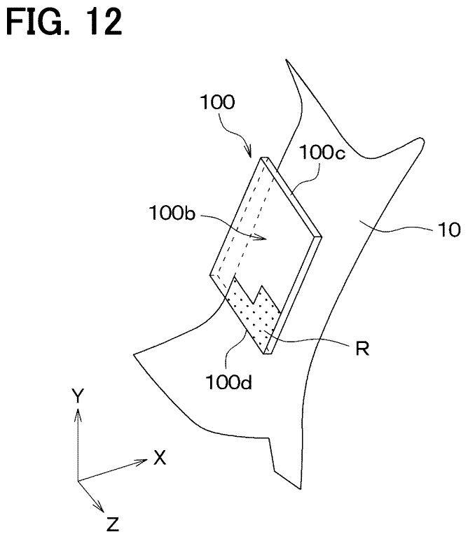

It is assumed that the light guide 100 is mounted to the mounting member 10 such that the prism extending direction coincides with the Y-axis direction. At this time, when the external scene light L1 travels toward the user's viewpoint position EP via the light guide 100, the external scene light L1 enters only through a portion of a region of the incident portion 100a, while in other regions of the incident portion 100a, the external scene light L1 does not enter. As a result, there are regions on the exit surface 100b of the light guide 100 where the incident light L2 does not reach. In other words, there are regions where the exited light L3 is not exited to the outside. As shown in FIGS. 9, 10, these regions are recognized by the user as invisible areas R where the scene cannot be visually recognized. It should be noted that FIG. 10 and FIG. 12, which will be described later, are diagrams showing a state in which the light guide 100 and the mounting member 10 are viewed from the viewpoint position EP on the driver's seat side, in a case where the mounting member 10 is an A-pillar.

In a mounting state shown in FIG. 9, since the prism extending direction of the light guide 100 is aligned with the Y-axis direction, refraction that deviates from the Z-axis direction does not occur, or if it does occur, it remains minimal. In addition, in FIGS. 9 and 10, hatching is applied to the invisible region R to make it easier to understand, although these figures do not show cross-sectional views. The same applies to FIGS. 11 to 13, which will be described later.

In addition, even when the light guide 100 is arranged, for example as shown in FIG. 11, along the inclined portion of the mounting member 10 with the prism extending direction inclined relative to the Y-axis direction, the invisible region R is generated. In this case, since the entire incident portion 100a of the light guide 100 protrudes from the mounting member 10, the external scene light L1 enters the entire area of the incident portion. At this time, in the YZ plane, since the prism extending direction is inclined with respect to the Y-axis direction and the light guide 100 is made of the transparent material with the refractive index n, the incident light L2 is refracted so as to deviate from the Z-axis direction. However, since the upper surface 100c and the lower surface 100d are inclined with respect to the Z-axis direction, a part of the lower surface 100d side of the exit surface 100b becomes a region where the incident light L2 does not reach due to the above refraction. Therefore, as shown for example in FIG. 11 and in FIG. 12, which shows FIG. 11 from a different angle, a part of the region on the lower surface 100d side of the exit surface 100b is recognized by the user as the invisible region R, which does not exit the exited light L3. Thus, when viewed from the exit surface 100b, the rectangular light guide 100 presents the invisible region R when it is mounted to the mounting member 10.

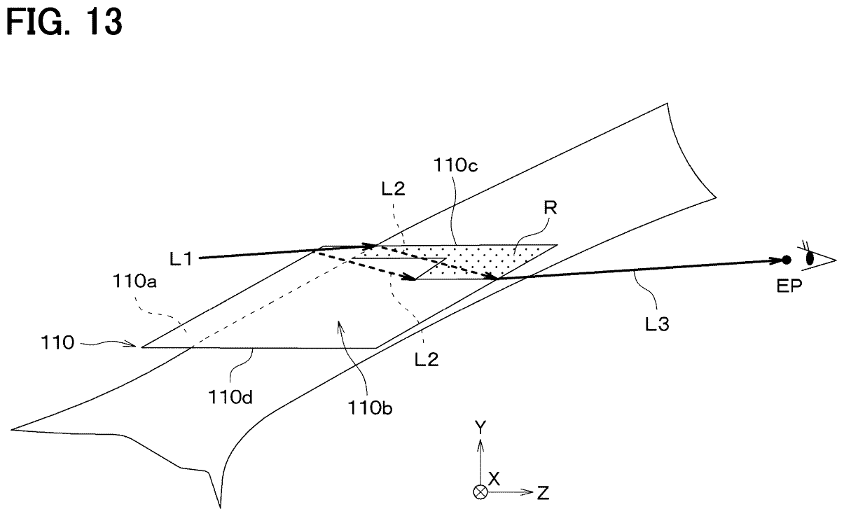

Next, the occurrence of the invisible region in the light guide 110 of a second comparative example shown in FIG. 13, for example, will be described.

A light guide 110 has an incident portion 110a, an exit surface 110b, a reflective surface (not shown), lateral surfaces and end surfaces, an upper surface 110c, and a lower surface 110d, and is basically configured in the same manner as the light guide 100, which is made of the translucent material. The light guide 110, when viewed from the exit surface 110b side, has a parallelogram shape and differs from the light guide 100 in that the extension direction of incident prism portions (not shown) constituting the incident portion 110a is not perpendicular to a direction defined by the upper surface 110c and the lower surface 110d.

Even when the light guide 110 is disposed, for example as shown in FIG. 13, along the inclined portion of the mounting member 10 with the prism extension direction of the incident portion 110a tilted relative to the Y-axis direction, an invisible region R is generated. In this case, the entire region of the incident portion 100a of the light guide 110 protrudes from the mounting member 10, the external scene light L1 enters this entire region, and the upper surface 110c and the lower surface 110d are aligned along the Z-axis direction. However, in this case, a portion of the upper surface 110c side of the exit surface 110b of the light guide 110 becomes a region where the incident light L2 does not reach due to refraction. Therefore, the light guide 110 is recognized by the user as having the invisible region R in which a portion of the upper surface 110c side of the exit surface 110b does not exit the exited light L3.

As described above, when the comparative light guides 100 and 110 are attached to the mounting member 10 having the inclined portion inclined with respect to the vertical direction, either external scene light L1 does not enter a part of the incident portion, or the invisible region R is generated due to refraction upon incidence.

Contrary to this, in the light guide 2 according to the present embodiment, in order to reduce the invisible region R, the first inclination angle ωu of the upper surface 2f and the second inclination angle ωd of the lower surface 2g are configured such that ωu≤ω and ωd≤ω with respect to the reference inclination angle ω, respectively. The reference inclination angle ω is an angle that serves as the standard for the inclination angles of the upper surface 2f and the lower surface 2g, satisfying ωo−10°≤ω≤ωo+10°, where an ideal angle ωo (in degrees) is calculated by the following equations (5) and (6).

$$\begin{matrix}< Math 5 > & \\ α = {sin}^{- 1} ( \sqrt{( {sin}^{2} ( ϕ x ) + {sin}^{2} ( ϕ y ) ) / ( 1 + 1 / ta {n}^{2} ( δ + θ z ) )} ) & ( 5 )\end{matrix}$$

$$\begin{matrix}< Math 6 > & \\ ω0 = {sin}^{- 1} ( s i n ( θ x + α ) / {n}^{c o s ψ x} ) & ( 6 )\end{matrix}$$

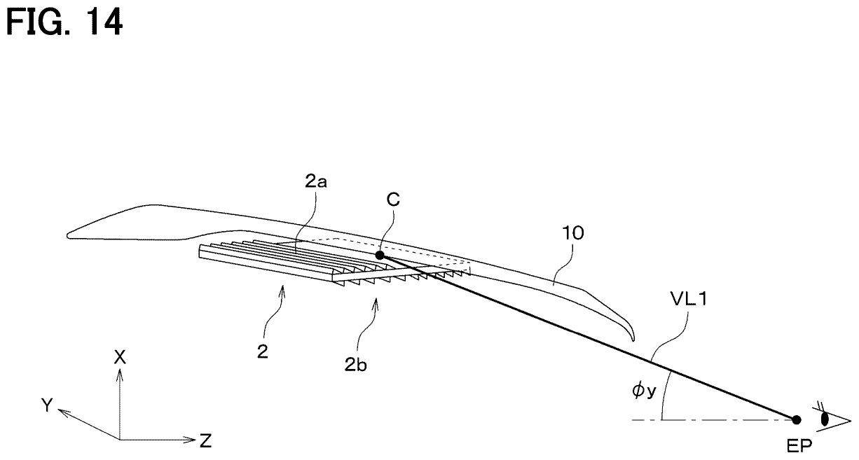

In equation (5), “α” refers to an angle (in degrees) formed between the external scene light L1 incident on the incident portion 2a and the z-direction, as shown in FIG. 4. “α” corresponds to an apparent incident angle, with respect to the z-direction, of the external scene light L1 that ultimately becomes the exited light L3 reaching the user's viewpoint position EP. In equation (5), “φy” refers to an angle (in degrees) on the XZ plane between a virtual straight line VL1 connecting the user's viewpoint position EP and point C on the terminal edge 2b1, and the Z-axis direction, as shown for example in FIG. 14. In other words, “φy” corresponds to an incident angle on the XZ plane, with respect to the viewpoint position EP, of the exited light L3 that is exited from point C among the incident light L2 entering from the incident portion 2a and reaches the viewpoint position EP. In equation (5), “δ” is an angle determined by a degree of inclination of the light guide 2, which is attached to the mounting member 10, in the YZ plane and the XZ plane, and is calculated by the following equation (7).

$$tan δ = sin φ x / sin φ y \qquad ( 7 )$$

The angle ωo corresponds to a tilt angle, with respect to the z direction, of the incident light L2 that has been refracted after entering the inside of the light guide 2 with refractive index n, following the entry of external scene light L1 into the incident portion 2a at an incident angle α. Here, the light guide 2 is assumed to be mounted on the mounting member 10 such that the upper surface 2f is on the upper side in the Y-axis direction and the lower surface 2g is on the lower side in the Y-axis direction. At this time, by adjusting the first inclination angle ωu so that the upper surface 2f satisfies ωu≤ωo, the incident light L2 reaches the entire region on the upper surface 2f side of the exit surface 2b, thereby suppressing the occurrence of the non-visible region R. Further, by adjusting the second inclination angle ωd so that the lower surface 2g satisfies ωd≤ωo, the incident light L2 reaches the entire region on the lower surface 2g side of the exit surface 2b, thereby suppressing the occurrence of the non-visible region R. Then, by configuring a system so that ωu≤ω and ωd>ω are satisfied with respect to the inclination reference angle ω, which is defined within a range of ±10° relative to the angle ω, the light guide 2 minimizes the occurrence of the non-visible region R. This allowable range of ±10° is set in consideration of factors such as processing errors of the light guide 2 and angular errors during its mounting onto the mounting member 10.

According to the present embodiment, by having the upper surface 2f of the light guide 2 satisfy ωu≤ω and the lower surface 2g satisfy ωd>ω, the optical member 1 is configured so that the occurrence of the non-visible region R is reduced. Further, by having the cross-sectional light guide distance Wd of the optical member 1 satisfy equation (4), the parallax ψ at a viewing distance D=3 m is kept at 1° or less, thereby reducing the decrease in visibility caused by parallax. The optical member 1 also has the following features.

The point C, which is one end of the virtual straight line VL1, is the center of the end edge 2b1. As a result, the ideal angle ωo is defined at the center between the upper surface 2f and the lower surface 2g of the light guide 2, making it possible to efficiently reduce the occurrence of the non-visible region R on either the upper surface 2f side or the lower surface 2g side of the exit surface 2b, thereby providing the optical member 1 with improved performance.

### Second Embodiment

Next, an optical member 1 according to a second embodiment will be described. The optical member 1 of the present embodiment differs from the first embodiment described above in that the design of inclination angles ωu and ωd of an upper surface 2f and a lower surface 2g has been changed. In the present embodiment, the following description will mainly focus on this point of difference.

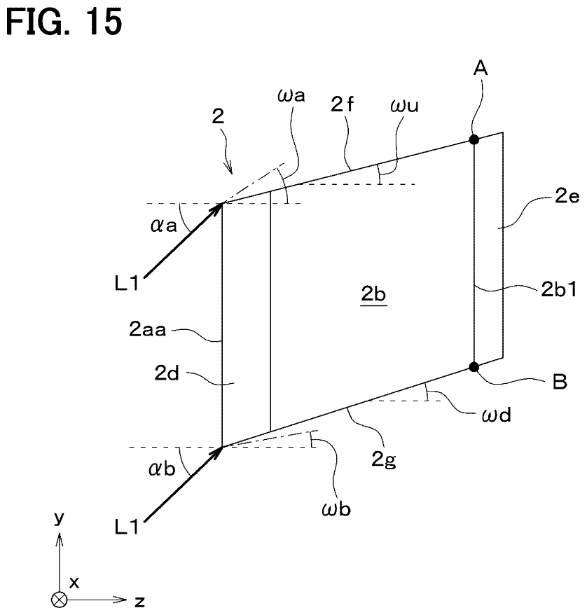

In the present embodiment, as shown for example in FIG. 15, the upper surface 2f has an upper limit value ωa for an ideal angle calculated by taking αa as an apparent incident angle of the external scene light L1 on the upper surface 2f side of the incident portion 2a. The angle αa is the apparent incident angle between the external scene light L1, which passes through a first endpoint A and ultimately becomes the exited light L3 reaching the user's viewpoint position EP, and the z-direction. In the present embodiment, for the lower surface 2g, a lower limit value ωb of an ideal angle is calculated by taking αb as the apparent incident angle of the external scene light L1 on the lower surface 2g side of the incident portion 2a. The angle αb is the apparent incident angle between the external scene light L1, which passes through a second endpoint B and ultimately becomes the exited light L3 reaching the user's viewpoint position EP, and the z-direction. These incident angles αa and αb, as well as the upper limit value ωa and the lower limit value ωb, are each calculated according to the following equations (8) through (11), respectively.

$$\begin{matrix}< Math 8 > & \\ α a = {sin}^{- 1} ( \sqrt{( {sin}^{2} ( ϕx a ) + {sin}^{2} ( ϕy a ) ) / ( 1 + 1 / {tan}^{2} ( δ a + θz ) )} ) & ( 8 )\end{matrix}$$

$$\begin{matrix}< Math 9 > & \\ α b = {sin}^{- 1} ( \sqrt{( {sin}^{2} ( ϕ x b ) + {sin}^{2} ( ϕ y b ) ) / ( 1 + 1 / {tan}^{2} ( δ b + θ z ) )} ) & ( 9 )\end{matrix}$$

$$\begin{matrix}< Math 10 > & \\ ω a = {sin}^{- 1} ( sin ( θ x + α a ) / {n}^{c o s ψ x} ) & ( 10 )\end{matrix}$$

$$\begin{matrix}< Math 11 > & \\ ω b = {sin}^{- 1} ( sin ( θ x + α b ) / {n}^{c o s ψ x} ) & ( 11 )\end{matrix}$$

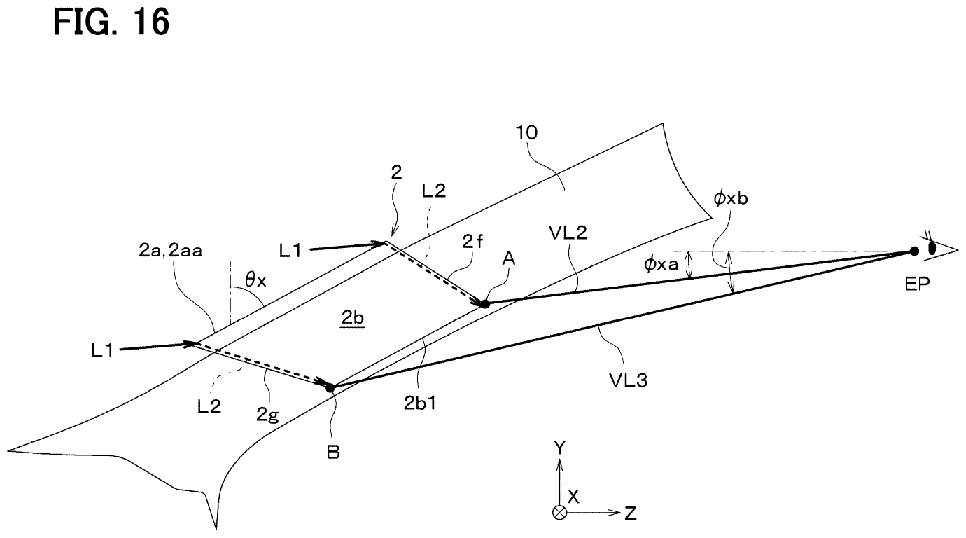

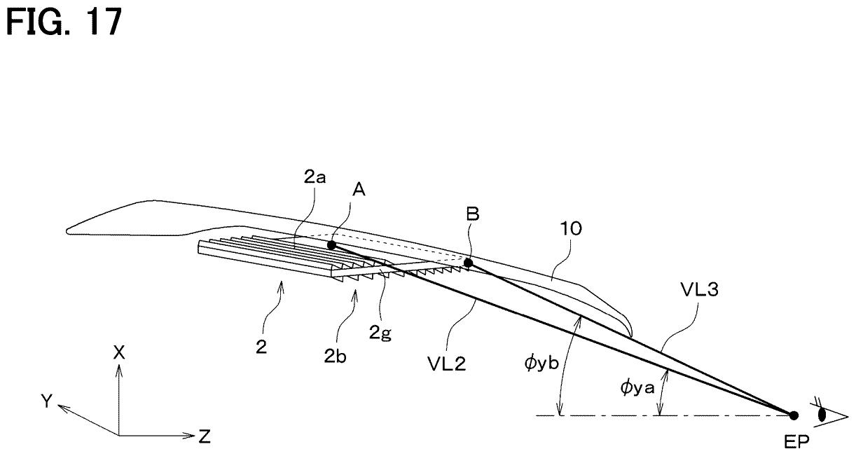

In equation (8), “φxa” refers to an angle (in degrees) on the YZ plane between a virtual straight line VL2, which connects the user's viewpoint position EP and the first endpoint A on the upper surface 2f side of the terminal edge 2b1, as shown for example in FIG. 16, and the Z-axis direction. The angle “φxa” corresponds to an incident angle, on the YZ plane, at which the exited light L3, which is exited from the first endpoint A among the incident light L2 that has entered through the incident portion 2a, reaches the viewpoint position EP. In equation (8), “φya” refers to an angle (in degrees) on the XZ plane between the aforementioned virtual straight line VL2 and the Z-axis direction, as shown for example in FIG. 17. The angle “φya” corresponds to an incident angle, on the XZ plane, at which the exited light L3, which is exited from the second endpoint B among the incident light L2 that has entered through the incident portion 2a, reaches the viewpoint position EP. In equation (8), “δa” is an angle determined by the inclination of the light guide 2, which is attached to the mounting member 10, on the YZ plane and the XZ plane, and is calculated by the following equation (12).

$$tan δ a = sin φ xa / sin φ ya \qquad ( 12 )$$

In equation (9), “φxb” refers to an angle (in degrees) on the YZ plane between a virtual straight line VL3, which connects the user's viewpoint position EP and the second endpoint B on the lower surface 2g side of the terminal edge 2b1 (as shown, for example, in FIG. 16), and the Z-axis direction. In equation (9), “φyb” refers to an angle (in degrees) on the XZ plane between the aforementioned virtual straight line VL3 and the Z-axis direction, as shown for example in FIG. 17. In equation (9), “δb” is an angle determined by the inclination of the light guide 2, which is attached to the mounting member 10, on the YZ plane and the XZ plane, and is calculated by the following equation (13). In the present embodiment, when the virtual straight line VL2 is defined as a first virtual straight line, the virtual straight line VL3 serves as a second virtual straight line.

$$tan δ b = sin φ xb / sin φ yb \qquad ( 13 )$$

When the first inclination angle ωu of the upper surface 2f of the light guide 2 is equal to or less than the upper limit value ωa, the incident light L2 reaches the entire area on the upper surface 2f side of the exit surface 2b, thereby suppressing the occurrence of the non-visible region R. When the second inclination angle ωd of the lower surface 2g of the light guide 2 is equal to or greater than the lower limit value ωb, the incident light L2 reaches the entire area on the lower surface 2g side of the exit surface 2b, thereby suppressing the occurrence of the non-visible region R. In the present embodiment, as described above, the light guide 2 is designed such that the upper limit value ωa of the first inclination angle ωu of the upper surface 2f and the lower limit value ωb of the second inclination angle ωd of the lower surface 2g are individually set, thereby efficiently suppressing the occurrence of the non-visible region R without waste.

Furthermore, taking into consideration effects of processing errors of the light guide 2 and angular errors during attachment to the mounting member 10, providing a tolerance range of 10° for the upper limit value ωa and the lower limit value ωb minimizes the occurrence of the non-visible region R. In other words, the occurrence of the non-visible region R is minimized when the upper surface 2f of the light guide 2 satisfies ωa−10°≤ωu≤ωa, and the lower surface 2g satisfies ωb≤ωd≤ωb+10°.

The present embodiment also provides the optical member 1 that can achieve effects similar to those of the first embodiment. Furthermore, since the optical member 1 is designed with central values of the inclination angles ωu and ωd for the upper surface 2f and the lower surface 2g of the light guide 2 individually set, the occurrence of the non-visible region R can be reduced more efficiently and without waste.

### Third Embodiment

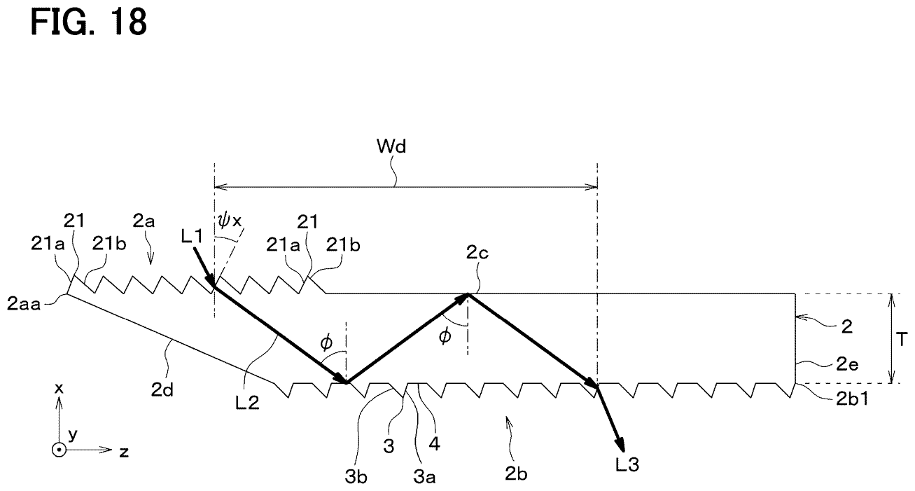

Next, an optical member 1 according to a third embodiment will be described. The optical member 1 of the present embodiment differs from the first embodiment described above in that, for example as shown in FIG. 18, a configuration of an exit surface 2b has been modified. In the present embodiment, the following description will mainly focus on this point of difference.

In the present embodiment, the exit surface 2b is configured such that, across its entire area, exit prism portions 3 and flat portions 4 are alternately and repeatedly arranged. For example, the exit surface 2b has a constant pitch between adjacent exit prism portions 3 and includes only a single region for exiting and internally reflecting the incident light L2. In addition, let k (where k is an integer of 1 or greater) denote a maximum number of round trips of the incident light L2 in the present embodiment, and let T (unit: mm) denote a distance in the x-direction between the flat portion 4 and the reflective surface 2c, that is, a thickness of the light guide 2. At this time, the cross-sectional light guiding distance Wd is calculated as a distance traveled by the light while making (k+½) round trips within the light guide 2 of thickness T.

The present embodiment also provides the optical member 1 that can achieve effects similar to those of the first embodiment.

### Fourth Embodiment

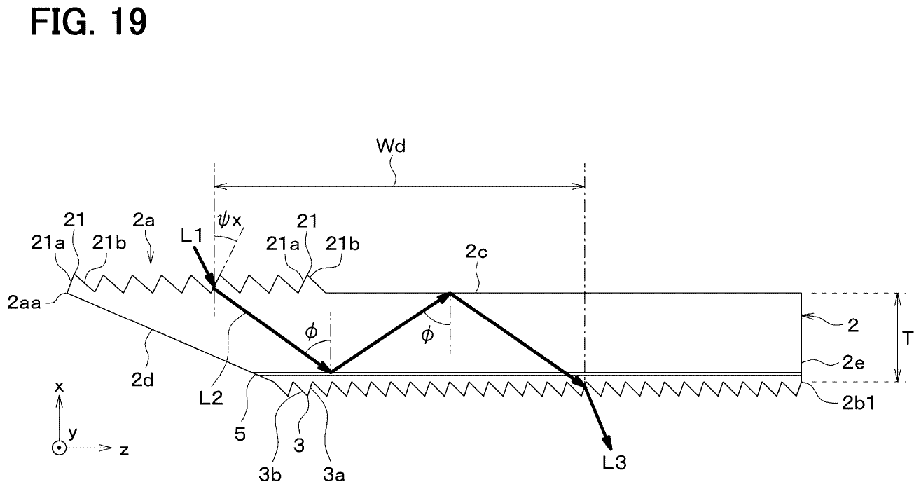

Next, an optical member 1 according to a fourth embodiment will be described. The optical member 1 of the present embodiment differs from the first embodiment in that, for example as shown in FIG. 19, a configuration of an exit surface 2b is modified and it further includes a reflective portion 5 that is independent from the exit surface 2b. In the present embodiment, the following description will mainly focus on this point of difference.

In the present embodiment, the exit surface 2b is provided only with exit prism portions 3 across its entire area, and is configured such that the exit prism portions 3 are arranged in a repeating pattern. In other words, in the present embodiment, the exit surface 2b serves as a region solely for exiting the incident light L2.

The reflective portion 5 is disposed between the incident portion 2a and the reflective surface 2c, and the exit surface 2b, and is arranged parallel to these components. The reflective portion 5, as shown for example in FIG. 19, is composed of a half mirror that transmits a portion of the incident light L2 from the incident portion 2a or the reflective surface 2c side toward the exit surface 2b side, while reflecting another portion of the incident light L2 toward the reflective surface 2c side. The reflective portion 5 is composed, for example, of a metallic material and is formed by a vacuum deposition method such as evaporation or sputtering. The reflective portion 5 is a light-transmitting material that allows a portion of visible light to pass through, and at the same time, it is a reflective material that reflects another portion of visible light.

In the present embodiment, the light guide 2 is divided into an upper portion, which is an upper half located on the reflective surface 2c side of the reflective portion 5, and a lower portion, which is a lower half located on the exit surface 2b side of the reflective portion 5. The upper portion and the lower portion are each composed of a transparent resin material. The reflective portion 5 is formed in either the upper portion or the lower portion. After the reflective portion 5 is formed, the upper portion and the lower portion are integrated. In the present embodiment, the cross-sectional light guide distance Wd is defined, as in the third embodiment, based on the maximum number of round trips of the incident light L2.

The present embodiment also provides the optical member 1 that can achieve effects similar to those of the first embodiment.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An optical member configured to be attached to a mounting member inclined with respect to a vertical direction, the optical member guiding external scene light from a region including a blind spot region caused by the mounting member, the optical member comprising:
a light guide body made of a light-transmissive material having a refractive index n, wherein
the light guide body includes:
an incidence portion including incident prism portions having an incidence surface through which the external scene light enters an interior;
an exit surface having exit prism portions, the exit surface including an exit portion that exits a part of incident light from the incidence surface to an outside;
a reflective portion that reflects another part of the incident light;
a reflective surface that reflects light reflected by the reflective portion toward the exit surface;
a terminal surface connecting an end portion of the reflective surface opposite to the incidence surface and the exit surface;
an upper surface connecting the incidence portion and the exit surface; and
a lower surface connecting the incidence portion and the exit surface and positioned opposite to the upper surface;
an up-down direction along a vertical direction is a Y-axis direction, a left-right direction orthogonal to the Y-axis direction and connecting the light guide body and the mounting member is an X-axis direction, a front-rear direction orthogonal to both the X-axis direction and the Y-axis direction is a Z-axis direction, a plane formed by the X-axis direction and the Y-axis direction is an XY plane, a plane formed by the Y-axis direction and the Z-axis direction is a YZ plane, and a plane formed by the X-axis direction and the Z-axis direction is an XZ plane, an edge of the incidence portion at an end opposite to the reflective surface is an incidence edge, and an edge of the exit surface at an end on the terminal surface side is a terminal edge,
the light guide body is arranged such that, with respect to the Y-axis direction, the incidence edge is inclined at an angle θx in the YZ plane and at an angle θz in the XY plane,
a straight line connecting a point on the terminal edge and a user's viewpoint position is a virtual line, an angle between the virtual line and the Z-axis direction in the YZ plane is φx, and an angle between the virtual line and the Z-axis direction in the XZ plane is φy, a direction in which the exit prism portions are arranged and which is orthogonal to an extending direction of the exit prism portions is a small-z-direction, an apparent incident angle between the external scene light incident on the incidence portion and the small-z-direction is α, and an angle between the incidence surface and a normal direction to the reflective surface is ψx, and sin φx/sin φy=tan δ,
$$α = {sin}^{- 1} ( \sqrt{( {sin}^{2} ( ϕ x ) + {sin}^{2} ( ϕ y ) ) / ( 1 + 1 / {tan}^{2} ( δ + θ z ) )} ) \qquad ( i )$$
$$ω0 = {sin}^{- 1} ( sin ( θ x + α ) / {n}^{c o s ψ x} ) \qquad ( ii )$$
an angle between the upper surface or the lower surface and the small-z-direction, which is an ideal angle calculated by equation (i) and equation (ii), is ωo, and an angle ω satisfying 0≤ω≤10 is an inclination reference angle, an actual angle between the upper surface and the small-z-direction is ωu, and an actual angle between the lower surface and the small-z-direction is ωd,
the upper surface satisfies ωu≤ω, and the lower surface satisfies ωd≥ω, and
among the light exited from the exit surface, the light having a largest number of round trips between the reflective portion and the reflective surface is maximum round-trip light, and a distance traveled by the maximum round-trip light from the incidence portion to the exit portion in a direction orthogonal to the incidence edge in a plane of the reflective surface is Wd, and Wd satisfies equation (iii)
$$W d \leq \frac{\frac{52 \times cos ω}{cos θ z}}{sin ( ϕ x + θ x - ω )} . \qquad ( iii )$$

2. The optical member according to claim 1, wherein
the point on the terminal edge is a center of the terminal edge.

3. The optical member according to claim 1, wherein
an endpoint of the terminal edge on the upper surface side is a first endpoint, an endpoint of the terminal edge on the lower surface side is a second endpoint, a straight line connecting the first endpoint and the viewpoint position is a first virtual line, a straight line connecting the second endpoint and the viewpoint position is a second virtual line, an angle between the first virtual line and the Z-axis direction in the YZ plane is φxa, an angle between the first virtual line and the Z-axis direction in the XZ plane is φya, an angle between the second virtual line and the Z-axis direction in the YZ plane is φxb, an angle between the second virtual line and the Z-axis direction in the XZ plane is φyb, an apparent incident angle between the external scene light and the small-z-direction at an end of the incidence portion on the upper surface side is αa, an apparent incident angle between the external scene light and the small-z-direction at an end of the incidence portion on the lower surface side is αb, sin oxa/sin φya=tan δa, and sin φxb/sin φyb=tan δb,
$$α a = {sin}^{- 1} ( \sqrt{( {sin}^{2} ( ϕ x a ) + {sin}^{2} ( ϕ ya ) ) / ( 1 + 1 / {tan}^{2} ( δ a + θ z ) )} ) \qquad ( iv )$$
$$α b = {sin}^{- 1} ( \sqrt{( {sin}^{2} ( ϕ x b ) + {sin}^{2} ( ϕ y b ) ) / ( 1 + 1 / {tan}^{2} ( δ b + θ z ) )} ) \qquad ( v )$$
$$ω a = {sin}^{- 1} ( sin ( θ x + α a ) / {n}^{c o s ψ x} ) \qquad ( vi )$$
$$ω b = {sin}^{- 1} ( sin ( θ x + α b ) / {n}^{c o s ψ x} ) \qquad ( vii )$$
an upper limit value of an ideal angle calculated by equation (iv) and equation (vi), which is an angle between the upper surface and the small-z-direction, is ωa, a lower limit value of an ideal angle calculated by equation (v) and equation (vii), which is an angle between the lower surface and the small-z-direction is ωb, an actual angle between the upper surface and the small-z-direction is ωu, and an actual angle between the lower surface and the small-z-direction is ωd,
$$the upper surface satisfies ω a - 10 ° \leq ω u \leq ω a , and the lower surface satisfies ω b \leq ω d \leq ω b + 10 ° .$$

4. The optical member according to claim 1, wherein
the reflective portion is one of reflective portions,
the reflective portions are flat portions made of the light-transmissive material, and
the reflective portions and the exit prism portions are the exit surface.

5. The optical member according to claim 4, wherein
the exit surface has a configuration in which the exit prism portions and the flat portions are alternately arranged.

6. The optical member according to claim 1, wherein
the exit surface is composed only of the exit prism portions,
the reflective portion is a half mirror disposed between the incidence portion and the exit surface and disposed between the reflective surface and the exit surface, and
the half mirror is configured to transmit a part of the incident light toward the exit surface and reflect another part of the incident light toward the reflective surface.
